(19) United States
(12) Patent Application Publication
(10) Pub. No.: US 2023/0351245 A1
(43) Pub. Date: Nov. 2, 2023

(54) FEDERATED LEARNING

(71) Applicant: Nokia Technologies Oy, Espoo (FI)

(72) Inventors: Tejas SUBRAMANYA, Munich (DE); Saurabh KHARE, Bangalore (IN); Chaitanya AGGARWAL, Munich (DE)

(21) Appl. No.: 17/734,510

(22) Filed: May 2, 2022

(51) Int. Cl. G06N 20/00; H04W 4/20

(52) U.S. Cl. CPC G06N 20/00; H04W 4/20

(57) ABSTRACT

According to an example aspect of the present invention, there is provided an apparatus configured to obtain reliability values for each user equipment in a group of user equipments, obtain, for each user equipment in the group, a reliability value for a training data set stored in the user equipment, each user equipment storing a distinct training data set, and direct a subset of the group of user equipments to separately perform a machine learning training process in the user equipments in the subset, wherein the apparatus is configured to select the subset based on the reliability values for the user equipments and the reliability values for the training data sets.

### FIELD

The present disclosure relates to the field of machine learning.

### BACKGROUND

Training of a machine learning solution, using suitable training data, is performed to render the machine learning solution, such as an artificial neural network, a decision tree or a support-vector machine, usable in its intended task of classification or pattern recognition, for example. Training may, in general, be supervised learning, which uses training data, and unsupervised learning.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core, at least one memory including computer program code, the at least one memory and the computer program code being configured to, with the at least one processing core, cause the apparatus at least to obtain reliability values for each user equipment in a group of user equipments, obtain, for each user equipment in the group, a reliability value for a training data set stored in the user equipment, each user equipment storing a distinct training data set, and direct a subset of the group of user equipments to separately perform a machine learning training process in the user equipments in the subset, wherein the apparatus is configured to select the subset based on the reliability values for the user equipments and the reliability values for the training data sets.

According to a second aspect of the present disclosure, there is provided an apparatus comprising at least one processing core, at least one memory including computer program code, the at least one memory and the computer program code being configured to, with the at least one processing core, cause the apparatus at least to store a set of training data locally in the apparatus, provide, responsive to a request from a federated learning server, a reliability value for the set of training data to the federated learning server, and perform a machine learning training process using the set of training data as a response to an instruction from the federated learning server.

According to a third aspect of the present disclosure, there is provided an apparatus comprising at least one processing core, at least one memory including computer program code, the at least one memory and the computer program code being configured to, with the at least one processing core, cause the apparatus at least to receive, from a federated learning server, a request for reliability values for each user equipment in a group of user equipments identified in the request, obtain the requested reliability values, wherein the obtaining comprises collecting information on the user equipments comprised in the group, and providing the requested reliability values to the federated learning server and/or storing the requested reliability values to a network node distinct from the federated learning server.

According to a fourth aspect of the present disclosure, there is provided a method comprising obtaining, in an apparatus, reliability values for each user equipment in a group of user equipments, obtaining, for each user equipment in the group, a reliability value for a training data set stored in the user equipment, each user equipment storing a distinct training data set, and directing a subset of the group of user equipments to separately perform a machine learning training process in the user equipments in the subset, wherein the subset is selected based on the reliability values for the user equipments and the reliability values for the training data sets.

According to a fifth aspect of the present disclosure, there is provided a method, comprising storing a set of training data locally in an apparatus, providing, responsive to a request from a federated learning server, a reliability value of the set of training data to the federated learning server, and performing a machine learning training process using the set of training data as a response to an instruction from the federated learning server.

According to a sixth aspect of the present disclosure, there is provided an apparatus comprising means for obtaining reliability values for each user equipment in a group of user equipments, obtaining, for each user equipment in the group, a reliability value of a training data set stored in the user equipment, each user equipment storing a distinct training data set, and directing a subset of the group of user equipments to separately perform a machine learning training process in the user equipments in the subset, wherein the apparatus is configured to select the subset based on the reliability values for the user equipments and the reliability values for the training data sets.

According to a seventh aspect of the present disclosure, there is provided an apparatus comprising means for storing a set of training data locally in the apparatus, providing, responsive to a request from a federated learning server, a reliability value of the set of training data to the federated learning server, and performing a machine learning training process using the set of training data as a response to an instruction from the federated learning server.

According to an eighth aspect of the present disclosure, there is provided a non-transitory computer readable medium having stored thereon a set of computer readable instructions that, when executed by at least one processor, cause an apparatus to at least obtain reliability values for each user equipment in a group of user equipments, obtain, for each user equipment in the group, a reliability value of a training data set stored in the user equipment, each user equipment storing a distinct training data set, and direct a subset of the group of user equipments to separately perform a machine learning training process in the user equipments in the subset, wherein the subset is selected based on the reliability values for the user equipments and the reliability values for the training data sets.

According to a ninth aspect of the present disclosure, there is provided a non-transitory computer readable medium having stored thereon a set of computer readable instructions that, when executed by at least one processor, cause an apparatus to at least store a set of training data locally in the apparatus, provide, responsive to a request from a federated learning server, a reliability value of the set of training data to the federated learning server, and perform a machine learning training process using the set of training data as a response to an instruction from the federated learning server.

According to a tenth aspect of the present disclosure, there is provided a computer program configured to cause at least the following to be performed by a computer, when executed: obtaining reliability values for each user equipment in a group of user equipments, obtaining, for each user equipment in the group, a reliability value of a training data set stored in the user equipment, each user equipment storing a distinct training data set, and directing a subset of the group of user equipments to separately perform a machine learning training process in the user equipments in the subset, wherein the the subset is selected based on the reliability values for the user equipments and the reliability values for the training data sets.

### BRIEF DESCRIPTION OF THE DRAWINGS

FIG. 1 illustrates an example system in accordance with at least some embodiments of the present invention;

FIG. 2 illustrates an example system in accordance with at least some embodiments of the present invention;

FIG. 3 illustrates an example apparatus capable of supporting at least some embodiments of the present invention;

FIG. 4 illustrates signalling in accordance with at least some embodiments of the present invention, and

FIG. 5 is a flow graph of a method in accordance with at least some embodiments of the present invention.

### EMBODIMENTS

In solutions disclosed herein, an improved distributed machine learning training process may be implemented which results in more dependable trained machine learning solutions, such as, for example, artificial neural networks, decision trees or support-vector machines by employing reliability information derived for participating nodes and the training data these nodes have. This way the impact that unreliable nodes and low-quality training data may have on an end result of a distributed training mechanism may be reduced, yielding a clear technical advantage in terms of a better performing machine learning solution.

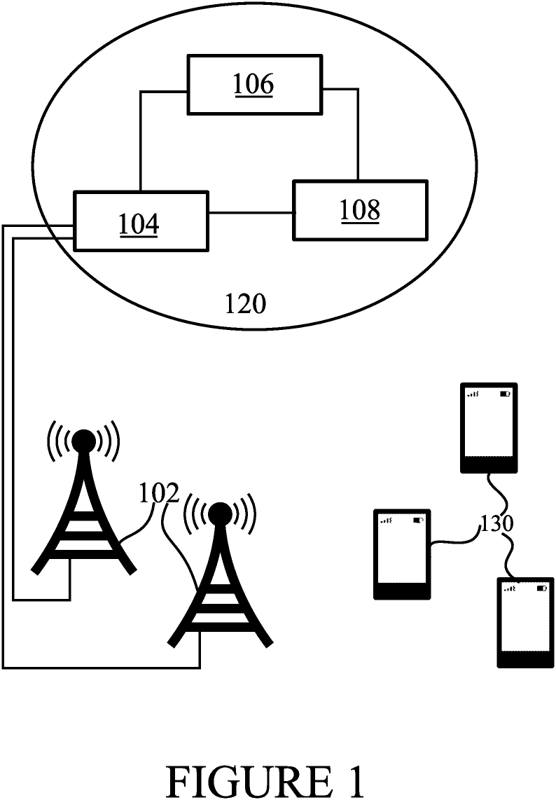

FIG. 1 illustrates an example system in accordance with at least some embodiments of the present invention. The illustrated system is a wireless communication network, which comprises a radio access network wherein are comprised base stations 102, and a core network 120 wherein are comprised core network nodes 104, 106 and 108. Depending on the technology used, base stations 102 may be referred to as access points, access nodes or node-b, eNb or gNb nodes. A network may have dozens, hundreds or even thousands of base stations. Examples of wireless communication networks include cellular communication networks and non-cellular communication networks. Cellular communication networks include wideband code division multiple access, WCDMA, long term evolution, LTE, and fifth generation, 5G, networks. Examples of non-cellular wireless communication networks include worldwide interoperability for microwave access, WiMAX, and wireless local area network, WLAN, networks.

User equipments, UEs, 130 communicate with base stations 102 using a suitable wireless air interface to achieve interoperability with the base stations. The UEs may comprise, for example, smartphones, mobile phones, tablet computers, laptop computers, desktop computers, and connected car communication modules, for example. The UEs may in some embodiments comprise Internet of Things, IoT, devices. The UEs may be powered by rechargeable batteries, and in some embodiments at least some of the UEs are capable of communicating with each other also directly using UE-to-UE radio links which do not involve receiving electromagnetic energy from base stations 102. The UEs have memory and processing capabilities, as well as sensor capabilities. In particular, the UEs may be capable of using their sensor capabilities to generate, locally in the UE, training data usable in a machine learning training process.

Core network nodes 104 and 106 may comprise, for example, mobility management entities, MMEs, gateways, subscriber registries, access and mobility management functions, AMFs, network data analytics functions, NWDAFs, and serving general packet radio service support nodes, SGSNs. The number of core network nodes may be higher than illustrated in FIG. 1. Core network nodes are logical entities, meaning that they may be physically distinct stand-alone devices or virtualized network functions, VNFs, run on computing substrates. In some network technologies, the radio access network comprises, in addition to base stations, also base station controllers. Core network node 108 comprises a distributed learning node, such as a federated learning server, for example. Distributed learning node 108 is configured to control aspects of distributed machine learning training, as will be disclosed in more detail herein below. The manner in which the nodes of the core network are connected in FIG. 1 is merely an example, there being a multitude of different ways the nodes may be connected with each other. Distributed learning node 108 may be run physically in a distributed manner, such that a part of its functions is run on a first computational substrate and a second part of its functions is run on a second computational substrate. Alternatively, distributed learning node 108 may be run on a single computational substrate.

Traditional machine learning, ML, approaches often involve centralizing the data that is collected by distributed nodes onto one single central node for training. To minimize data exchange between distributed nodes and the central node where model training is usually done, federated learning, FL, has been introduced. In FL, instead of training a model at a single distributed learning node 108, different versions of the model are trained at plural ones of distributed nodes, such a s UEs 130. That is, considering each distributed node has its own local data, the training is done in an iterative manner. During each iteration, distributed learning node 108, which may be referred to as a FL aggregator, for example, aggregates local models that are partially trained at the distributed nodes. Then a the aggregated single global model is sent back to the distributed nodes. This process may be repeated until the global model eventually converges to within a suitable threshold, which may be set according to the demands of the specific application at hand. An iterative FL process can be summarized with the following four steps:

Step 1: Selecting distributed nodes for local training, followed by local training in the selected distributed nodes. - The distributed learning node selects, for example either randomly or based on a distributed training node selection scheme, distributed nodes to use and may ask the K selected distributed nodes to download a trainable model from the distributed learning node. All K distributed nodes then compute training gradients or model parameters and then provide locally trained model parameters to distributed learning node 108.

Step 2: Model aggregating - distributed learning node 108 performs aggregation of the uploaded model parameters from the K distributed nodes. Step 3: Parameters broadcasting - distributed learning node 108 provides the aggregated model parameters to the K distributed nodes. Step 4: Model updating - the K distributed nodes update their respective local models with the received aggregated parameters and examine the performance of updated models. After several local training and update exchanges between distributed learning node 108 and its associated K distributed nodes, it is possible to achieve a global optimal learning model. The global optimum learning model may be defined in terms of a threshold for a loss function to be minimized, for example.

However, a challenge in distributed training is present in the nature of the distributed process. In particular in the case of UEs as the distributed nodes, UEs acting incorrectly or even maliciously may provide unreliable training parameters to distributed learning node 108, reducing the accuracy of the training process. This may result in inferior performance of the eventual trained machine learning model, or it at least slow down the distributed training process. Such behaviour may be the result of the UE using out-of-date versions of software, or being infected with malware, for example. Furthermore, the training data the UE has may be of low quality. For example, the training data may be patchy in nature, with missing data, or the data may be present, but the phenomena the machine learning solution is to be trained to detect may be absent in the training data in a particular UE. Thus, rather than selecting the UEs to participate in the distributed learning solution randomly or, for example, based simply on their subscription type, geographic location or connection type, distributed learning node 108 may enhance the quality of the trained machine learning solution by selecting the UEs based on the quality of their processing environment, and/or the quality of their training data. For example, of the phenomena the training is mean to study is absent in a certain area, UEs which have collected their training data from this certain area may be excluded from the distributed training process.

A reliability value for a UE may be obtained by distributed learning node 108, for example by requesting it from a NWDAF or other network node, such as analytics data repository function, ADRF. In some embodiments, the distributed learning node itself is configured to compile the reliability value for a UE based on information it has available, or information which it may request.

The reliability value for the UE may be based, for example, on one, two, more than two, or all of the following parameters: UE location, UE mobility prediction, network coverage report, UE abnormal behaviour analytics report, UE firmware version and historical data. The UE location may be retrieved from UDM, AMF or GMLC, for example. A mobility prediction, for example to figure out if the UE will leave network coverage soon, may be obtained from NWDAF, for example. A network coverage report may be retrieved from OAM, behaviour analytics reports from NWDAF, UE firmware versions from a subscriber register, and historical data from an ADRF, for example. Other parameters and/or solutions are possible, depending on the specific application and technology used in the network.

The UE reliability value may be a sum of scores given to parameters used in compiling the reliability value. For example in terms of the parameters given above, a higher score may be given to UEs which have been in a location where the phenomena the machine learning solution to be trained is interested in, which are predicted to remain in network coverage longer, which are not associated with reports of anomalous behaviour, which have newer versions of firmware, and which have been present in the network for longer. As a modification of this, it is possible to assign a minimum reliability value to all UEs which have been reported as behaving anomalously, to exclude them from the distributed learning process. Likewise a further parameter may be used to assign the minimum reliability value, alternatively to or in addition to the reports of anomalous behaviour.

Distributed learning node 108 may be configured to apply a threshold to UE reliability values, to obtain a group of reliable UEs, in the sense that for UEs comprised in the group, each UE has a UE reliability value that meets the threshold. Alternatively, distributed learning node 108 may obtain the group of UEs from a list it maintains of UEs that participate in distributed learning.

Distributed learning node 108 may request from UEs in the group reliability values for the training data that these UEs locally store. The UEs will responsively provide this reliability value after determining it locally. The reliability value for the training data may be based on a completeness value reflecting how many, or how few, data points are missing in the data, and distributed learning node 108 may also provide a metric in the reliability value request it sends to the group of UEs, concerning what it values in the training data, for example, it may provide a mathematical characteristic of the phenomena that the distributed training process is interested in to facilitate focussing on training data sets which have captured these phenomena. The reliability value may be a sum of scores of the completeness value and the metric received from the distributed learning node, as applied locally to the training data by the UE, for example.

Once distributed learning node 108 is in possession of the reliability values for the UEs in the group, and for each of these UEs the reliability value of the training data this UE stores, distributed learning node 108 may select from among the group a subset, such as a proper subset, based on the reliability values for the user equipments and the reliability values for the training data sets. How this selection is done depends on the implementation, for example, the distributed learning node may compile a compound reliability value for each UE from the UE reliability value and the training-data reliability value for this UE. The compound reliability values may then be compared to a specific threshold to choose the subset as the UEs meeting the specific threshold, or the UEs may be ordered based on the compound reliability values, with a predefined number of most reliable UEs then selected based on an assessment of how many UEs are needed. Alternatively to using a compound reliability value, the distributed learning node may be configured to select the subset as the set of UEs which meet both the threshold for the UE reliability value and a separate threshold for training set reliability values. In case a compound reliability value is generated, it may be stored in a network node for future reference by distributed learning node 108, or by another node. The network node may be an ADRF, for example. Alternatively or additionally to the compound reliability value, the reliability value for the user equipments may be stored in the network node, such as the ADRF, for example.

Once the subset of UEs is selected, the distributed learning node instructs UEs in the subset to separately, locally perform a machine learning training process in the UEs. Once this is complete, the UEs report their results to distributed learning node 108, which can then aggregate the results from the UEs of the subset, and initiate a subsequent round of distributed learning with the UEs of the subset, if needed. Thus distributed learning, such as federated learning, may be obtained using reliable distributed nodes and reliable training data.

When distributed learning node 108 is comprised in the core network 120, as in FIG. 1, it may communicate with UEs 130 using user-plane traffic, for example.

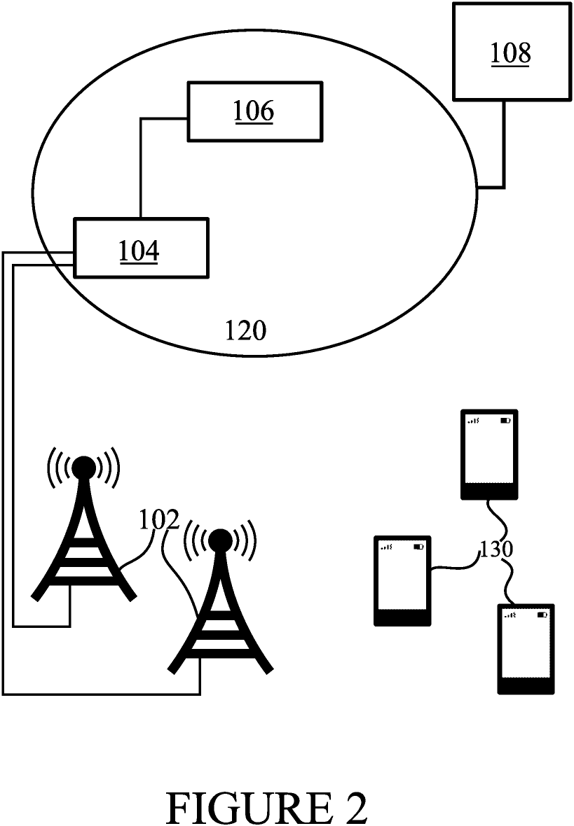

FIG. 2 illustrates an example system in accordance with at least some embodiments of the present invention. like numbering denotes like structure as in the system of FIG. 1. The system of FIG. 2 differs from the one in FIG. 1 in the location of distributed learning node 108, which is not in core network 120. Rather, it may be an external node which may communicate with UEs 130 and core network 120 using, for example, service-based architecture signalling or non-access stratum signalling. In the case of FIG. 2, distributed learning node 108 may be even in a different country, or continent, than core network 120. Communication between core network 120 and distributed learning node 108 may traverse the Internet, for example, wherein such communication may be secured using a suitable form of encryption. A single distributed learning node 108 outside core network 120 may be configured to coordinate federated learning in plural networks to which it may send instructions.

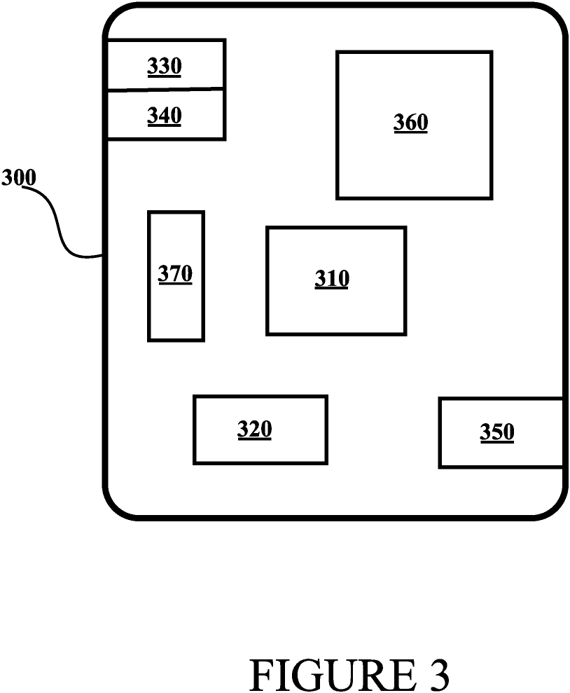

FIG. 3 illustrates an example apparatus capable of supporting at least some embodiments of the present invention. Illustrated is device 300, which may comprise, for example, in applicable parts, a distributed learning node 108, a computing substrate configured to run distributed learning node 108, or a UE 130, of FIG. 1 or FIG. 2. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. Processor 310 may be a control device. A processing core may comprise, for example, a Cortex-A8 processing core manufactured by ARM Holdings or a Zen processing core designed by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300, such as obtaining, directing, receiving, aggregating, requesting, storing, providing and performing. Processor 310 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory(ies) that work together to cause an apparatus, such as a UE or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to configure distributed-learning parameters.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, when device 300 is distributed learning node 108, it may lack NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

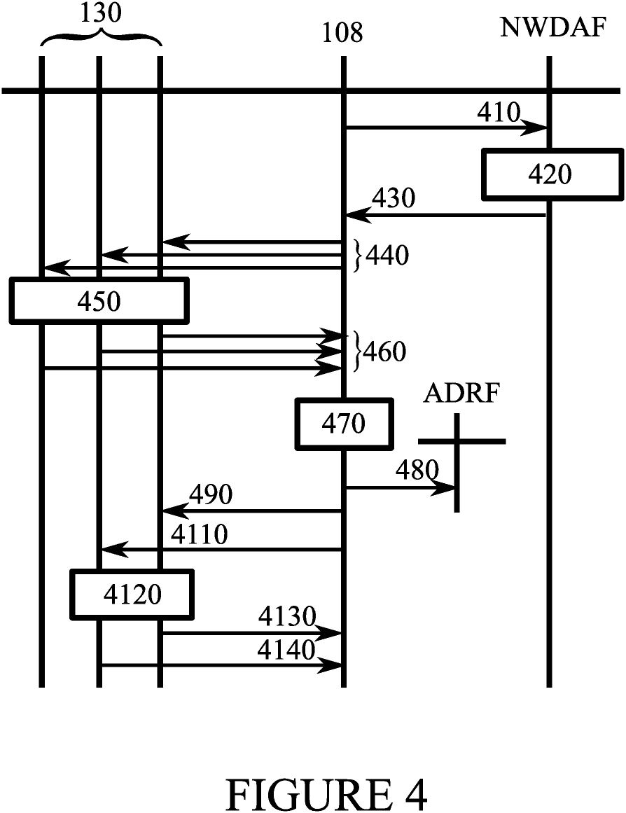

FIG. 4 illustrates signalling in accordance with at least some embodiments of the present invention. On the vertical axes are disposed, on the left, UEs 130, in the centre, distributed learning node 108 and on the right, NWDAF. Time advances from the top toward the bottom.

In phase 410, distributed learning node 108 requests reliability values for each user equipment in a group of UEs 130 from NWDAF. Alternatively, distributed learning node 108 may request, from the NWDAF or other node(s) the information needed to compile the reliability values for the UEs, and compile these reliability values itself. The message(s) of phase 410 may comprise, for example, an Nnwdaf_AnalyticsSubscription_Subscribe message. The request of phase 410 may identify the group of UEs using a group identifier, or the request may identify the UEs of the group by providing, or referring to, a list of UE identifiers.

In phase 420, the NWDAF obtains the requested reliability values for the UEs in the group. For this, the NWDAF may collect parameters, depending on the embodiment, from e.g. AMF, OAM or at least one another NWDAF, for example. For example, the NWDAF may be configured to rely on a number and/or type of identified exceptions that the UE(s) are prone to, exception levels of all identified exceptions, statistical or prediction based exception identification, confidence level of prediction based exceptions identified, operator’s polices, and/or other parameters, the NWDAF may assign a UE reliability value. An exception is an anomalous condition in computational processing, which requires processing. As one example, the UE reliability value may be obtained from [(Exception ID 1, Exception level, prediction-based, confidence of prediction), (Exception ID 2, Exception level, statistics-based), (Exception ID 3, Exception level, prediction-based, confidence of prediction)]. In other words, the reliability value may be either a mean, an average or a weighted average of exceptions. For example, in case of weighted averaging, exception ID 1 may have more weight than exception ID 2 since certain exceptions are inherently more dangerous to machine learning implementations than others. Further, determination of an exception based on historical statistics may be assigned more weight than a determination of an exception based on a prediction. When predicting exceptions is used, a confidence value assigned to the prediction may affect the weight given to the predicted exception.

In phase 430, the NWDAF responds to distributed learning node 108 by providing the reliability value(s) requested in phase 410. This may involve using, for example, Nnwdaf_AnalyticsSubscription_Notify or Nnwdaf_AnalyticsInfo_Response. The NWDAF may also, optionally, store the requested reliability value(s) for the UEs of the group to a network node, such as, for example, an ADRF. Thus other application functions, such as other distributed learning nodes, may access the reliability values without a need to re-generate them. In embodiments where distributed learning node 108 obtains the UE reliability values itself, phases 410 and 430 are absent, and phase 420 takes place in distributed learning node 108.

In phase 440, distributed learning node 108 requests from the UEs in the group their reliability values for their locally stored training data sets. Each UE has its own training data set, which it may have obtained using sensing, or it may have been provided to the UE by distributed learning node 108 or by another node. Responsively, in phase 450 the UEs in the group compile the requested reliability values for their respective training data sets, and in phase 460 each UE of the group provides its training data set reliability value to distributed learning node 108. As noted above, in some embodiments distributed learning node 108 forms the group based on the UE reliability values it received from the NWDAF (or generates itself).

In phase 470, distributed learning node 108 selects a subset of the group of UEs based on the reliability values for the UEs and the reliability values for the training data sets of the UEs, as described herein above. Of note is that in some embodiments, distributed learning node 108 employs supplementary information in addition to the UE reliability values and the training data set reliability values. Examples of suitable supplementary information include computational resource availability in the UEs, power availability in the UEs and communication link quality to the UEs. For example, the supplementary information may be used to exclude UEs from the subset which would be included if merely the reliability values were used. For example, if a specific UE is very constrained as to processing capability, then including it in the subset and the distributed training process would slow down the training process, as other nodes would wait for this UE to complete its local training process.

In optional phase 480, the compound reliability value, if generated, may be stored in a network node, such as the ADRF. Alternatively, especially if NWDAF didn’t store the reliability value for the UEs, distributed learning node 108 may store the reliability values for the UEs in the network node, such as the ADRF. This may take place at any time after phase 430, and not necessarily in the phase indicated in FIG. 4. The subset may be a proper subset.

In phases 490 and 4110, distributed learning node 108 instructs UEs in the subset to perform a machine learning training process locally in the UEs, using the training data sets stored locally in the UEs. The UEs of the subset perform the instructed training process in phase 4120, and report the results of the locally performed training processes back to perform a machine learning training process in phases 4130 and 4140.

Once distributed learning node 108 is in possession of the results from the UEs in the subset, it may aggregate them and, if necessary, initiate a new round of distributed machine learning training in the UEs of the subset by providing to the UEs of the subset aggregated parameters to serve as starting points to use, with the local training data sets, for a further local round of locally performed distributed machine learning training.

Optionally, distributed learning node 108 may inform the UEs of the group which are not included in the subset of their exclusion, optionally also with a reason code, such as failing to meet a threshold with respect to training data set reliability, for example. Based on the reason codes, the UEs may take corrective actions to be included in future distributed training processes.

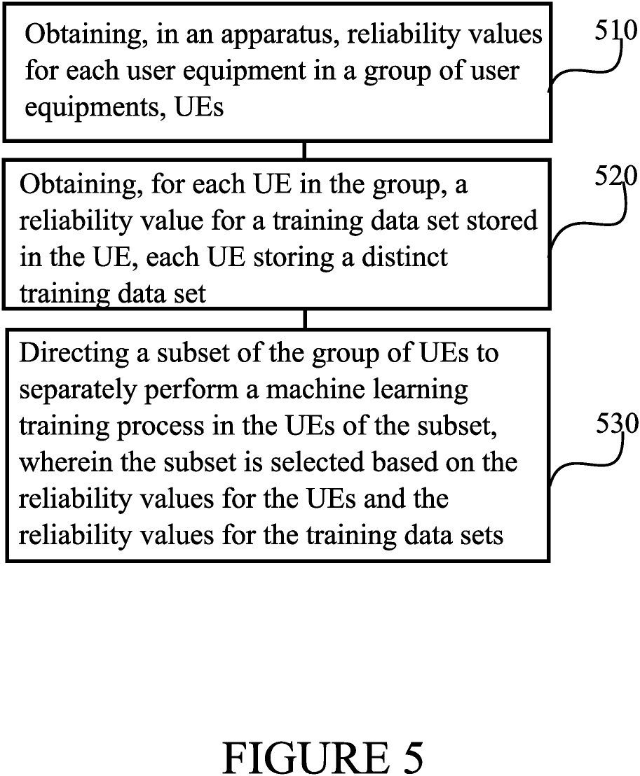

FIG. 5 is a flow graph of a method in accordance with at least some embodiments of the present invention. The phases of the illustrated method may be performed in distributed learning node 108, for example, or in a control device configured to control the functioning thereof, when installed therein.

Phase 510 comprises obtaining, in an apparatus, reliability values for each user equipment in a group of user equipments, such as, for example, cellular user equipments. Phase 520 comprises obtaining, for each user equipment in the group, a reliability value of a training data set stored in the user equipment, each user equipment storing a distinct training data set. Finally, phase 530 comprises directing a subset of the group of user equipments to separately perform a machine learning training process in the user equipments in the subset, wherein the subset is selected based on the reliability values for the user equipments and the reliability values for the training data sets.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in machine learning.

ACRONYMS LIST

| | |
|---|---|
| ADRF | analytics data repository function |
| AMF | access and mobility management functions |
| GMLC | gateway mobile location centre |
| NWDAF | network data analytics function |
| OAM | operations, administration and maintenance |
| UDM | unified data management node |

REFERENCE SIGNS LIST

| | |
|---|---|
| 102 | base stations |
| 104, 106 | core network nodes |
| 108 | distributed learning node |
| 120 | core network |
| 130 | user equipments |
| 300-370 | structure of the device of FIG. 3 |
| 410-4140 | phases of the process of FIG. 4 |
| 510-530 | phases of the process of FIG. 5 |

1. An apparatus comprising at least one processing core, at least one memory including computer program code, the at least one memory and the computer program code being configured to, with the at least one processing core, cause the apparatus at least to:
obtain reliability values for each user equipment in a group of user equipments;
obtain, for each user equipment in the group, a reliability value for a training data set stored in the user equipment, each user equipment storing a distinct training data set, and
direct a subset of the group of user equipments to separately perform a machine learning training process in the user equipments in the subset, wherein the apparatus is configured to select the subset based on the reliability values for the user equipments and the reliability values for the training data sets.

2. The apparatus according to claim 1, wherein the at least one memory and the computer program code are configured to, with the at least one processing core, cause the apparatus to receive, from each user equipment in the subset, a result of the machine learning training process performed by the user equipment.

3. The apparatus according to claim 2, wherein the at least one memory and the computer program code are configured to, with the at least one processing core, cause the apparatus to aggregate the results of the machine learning training processes received from the user equipments of the subset to obtain an aggregate machine learning result.

4. The apparatus according to claim 1, wherein the at least one memory and the computer program code are configured to, with the at least one processing core, cause the apparatus to obtain the reliability values for the user equipments in the group from a network data analytics function.

5. The apparatus according to claim 1, wherein the at least one memory and the computer program code are configured to, with the at least one processing core, cause the apparatus to obtain the reliability values for the training data sets by requesting from the user equipments in the group.

6. The apparatus according to claim 1, wherein the apparatus is configured to obtain, for each user equipment in the group, from the reliability value of the user equipment and the reliability value of the training data set stored in the user equipment, a compound reliability value of the user equipment, and to select the subset from among the group based on the compound reliability values of the user equipments of the group.

7. The apparatus according to claim 6, wherein the apparatus is further configured to store at least one of the compound reliability values of the user equipments of the group in a network node.

8. The apparatus according to claim 7, wherein the network node the apparatus is configured to store the at least one of the compound reliability values of the user equipments of the group in comprises an analytics data repository function.

9. The apparatus according to claim 1, wherein the apparatus is configured to receive information from the user equipments comprised in the subset using user plane traffic.

10. The apparatus according to claim 1, wherein the apparatus is configured to receive information from the user equipments comprised in the subset using service-based architecture signalling or non-access stratum signalling.

11. The apparatus according to claim 1, wherein the apparatus is configured to notify user equipments comprised in the group but not comprised in the subset, that they have been excluded from the machine learning training process.

12. An apparatus comprising at least one processing core, at least one memory including computer program code, the at least one memory and the computer program code being configured to, with the at least one processing core, cause the apparatus at least to:
store a set of training data locally in the apparatus;
provide, responsive to a request from a federated learning server, a reliability value for the set of training data to the federated learning server, and
perform a machine learning training process using the set of training data as a response to an instruction from the federated learning server.

13. A method comprising:
obtaining, in an apparatus, reliability values for each user equipment in a group of user equipments;
obtaining, for each user equipment in the group, a reliability value for a training data set stored in the user equipment, each user equipment storing a distinct training data set, and
directing a subset of the group of user equipments to separately perform a machine learning training process in the user equipments in the subset, wherein the subset is selected based on the reliability values for the user equipments and the reliability values for the training data sets.

14. The method according to claim 13, further comprising receiving, from each user equipment in the subset, a result of the machine learning training process performed by the user equipment.

15. The method according to claim 14, further comprising aggregating the results of the machine learning training processes received from the user equipments of the subset to obtain an aggregate machine learning result.

16. The method according to claim 13, wherein the obtaining of the reliability values for the user equipments in the group is from a network data analytics function.

17. The method according to claim 13, wherein the obtaining of the reliability values for the training data sets takes place by requesting from the user equipments in the group.

18. The method according to claim 13, further comprising obtaining, for each user equipment in the group, from the reliability value of the user equipment and the reliability value of the training data set stored in the user equipment, a compound reliability value of the user equipment, and selecting the subset from among the group based on the compound reliability values of the user equipments of the group.

19. A method, comprising:
storing a set of training data locally in an apparatus;
providing, responsive to a request from a federated learning server, a reliability value of the set of training data to the federated learning server, and
performing a machine learning training process using the set of training data as a response to an instruction from the federated learning server.
